(19) United States
(12) Patent Application Publication
(10) Pub. No.: US 2009/0230970 A1
(43) Pub. Date: Sep. 17, 2009

(54) Optimisation of Mtem Parameters

(76) Inventor: Anton Ziolkowski, Edinburgh (GB)

Correspondence Address: Mr Eugene Thigpen;Petroleum Feo-Services Inc, P O Box 42805, Houston, TX, 77242, US

(21) Appl. No.: 12/224,927

(22) PCT Filed: Mar. 9, 2007
(86) PCT No.: PCT/GB2007/000843

§ 371 Date: Feb. 5, 2009

(30) Foreign Application Priority Data
Mar. 10, 2006 (GB) 0604829.2

(51) Int. Cl. G01V 3/12

(52) U.S. Cl. 324/344

(57) ABSTRACT

A method of optimising electromagnetic surveying comprising applying current to a current source, receiving a signal at one or more voltage receivers and recording the signals received, characterised by varying one or more acquisition parameters as a function of the source-receiver separation.

The present invention relates to multi-transient electromagnetic (MTEM) surveys for estimating the response of the earth to electromagnetic pulses, thereby to detect hydrocarbon-bearing or water-bearing formations. In particular, the present invention relates to the optimisation of parameters for multi-transient electromagnetic (MTEM) surveys.

Porous rocks are saturated with fluids. The fluids may be water, gas, or oil, or a mixture of all three. The flow of current in the earth is determined by the resistivities of such rocks, which are affected by the saturating fluids. For instance, brine-saturated porous rocks are much less resistive than the same rocks filled with hydrocarbons. By measuring the resistivity of geological formations, it is possible to determine whether hydrocarbons are present. This is very useful, because if tests using other methods, for instance seismic exploration, suggest that a geological formation has the potential to bear hydrocarbons, resistivity measurements can be used before drilling begins to provide some indication as to whether the formation does in fact contain hydrocarbons or whether it is primarily water bearing.

An example of a resistivity based technique for identifying hydrocarbons uses time domain electromagnetic techniques. Conventionally, time domain electromagnetic investigations use a transmitter and one or more receivers. The transmitter may be an electric source, that is, a grounded bipole, or a magnetic source, such as a current in a wire loop or multi-loop. The receivers may be grounded bipoles for measuring potential differences, or wire loops or multi-loops or magnetometers for measuring magnetic fields and/or the time derivatives of magnetic fields. The transmitted signal is often formed by a step change in current in either an electric or magnetic source, but any transient signal may be used, including, for example, a pseudo-random binary sequence (PRBS). A PRBS is a sequence that switches between two levels at pseudo-random times that are multiples of an elemental time step Δt. The switching frequency of the PRBS is fₛ=1/Δt. A PRBS has a broad frequency bandwidth, whose upper limit is half the switching frequency fₛ.

In recent years, a promising new survey technique based on multi-channel transient electromagnetic signals has been investigated. The article “Hydrocarbon detection and monitoring with a multichannel transient electromagnetic (MTEM) survey” by Wright, D., Ziolkowski, A., and Hobbs, B., (2002), The Leading Edge, 21, 852-864, describes the multichannel transient electromagnetic method. In this case, there is a source, usually a current applied between a pair of grounded electrodes, and receivers, usually measuring the potential difference between electrodes along a line. This is also described in WO 03/023452.

Multi-transient electromagnetic surveys produce geophysical data that are similar in some respects to seismic reflection and seismic refraction data. The diffusion of electric currents in the earth is, however, fundamentally different from the propagation of sound waves through the same earth and the resulting responses differ profoundly, especially in the changing shape of the response with offset and overburden resistivity. The objective of a MTEM survey is to obtain a map of subsurface resistivity variations. The ability to make this map depends entirely on the quality of the measurements made. The present invention recognises this and establishes a framework for quality control of MTEM data to enable good quality data to be obtained for subsequent processing and inversion to make a map of subsurface resistivities.

According to a first aspect of the invention, there is provided a method of optimising electromagnetic surveying comprising applying current to a current bipole source, receiving a signal at one or more voltage bipole receivers and recording the signals received, characterised in that the method involves varying one or more acquisition parameters as a function of the source-receiver separation.

The invention resides in the realisation that the optimum data acquisition parameters for MTEM surveys can vary significantly as a function of the source-receiver separation. This has not been appreciated previously. This realisation has allowed the selection of optimum measurement parameters, where previously only experience and an element of guesswork were used. This is a significant advance in the art.

The acquisition parameters that are varied may be at least one of a switching frequency fₛ at the source and a sampling frequency fᵣ in the recording system. The switching frequency fₛ and the sampling frequency fᵣ are inversely proportional to the square of the source-receiver separation, and so in this case, the step of varying the switching frequency and/or the sampling frequency may be done inversely as the square of the source-receiver separation.

The separation between the source electrodes and the separation between receiver electrodes may be varied, preferably as a function of the target survey depth.

According to another aspect of the invention, there is provided an electromagnetic surveying system comprising a current bi-pole source, one or more voltage bipole receivers and a recorder for recording the signals received, characterised in that one or more acquisition parameters used by the source and/or the or each receiver is selected as a function of the source-receiver separation.

The acquisition parameters may be at least one of a switching frequency fₛ at the source and a sampling frequency fᵣ in the recording system. The switching frequency and/or the sampling frequency may be selected inversely as the square of the source-receiver separation.

Preferably, a plurality of receivers is provided and the source is operable to provide a current at a plurality of different frequencies, each frequency being selected as a function of the separation of one of the receivers from the source.

The source may be operable to provide current signals in a range of different bandwidths. Alternatively, the source may comprise a plurality of different sources each operable to provide current in a different frequency bandwidth.

The current source may comprise at least one current bipole source. The/each voltage receiver may comprise at least one voltage bipole receiver.

The separation between the source electrodes and the separation between receiver electrodes may be selected as a function of a target survey depth.

Various aspects of the present invention will now be described by way of example only and with reference to the accompanying drawings, of which:

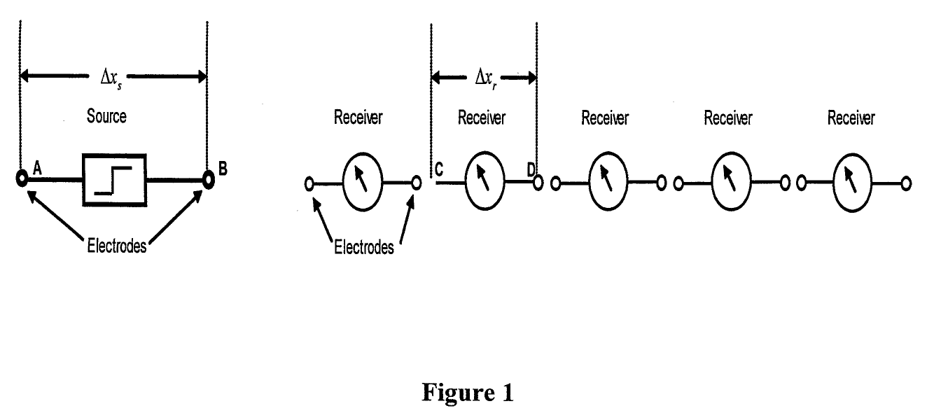

FIG. 1 is a block diagram of a MTEM source/receiver configuration;

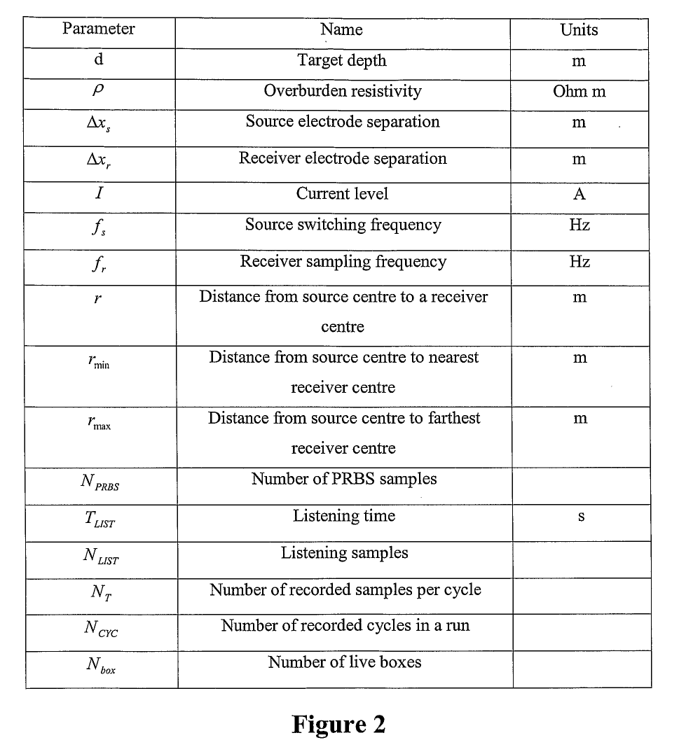

FIG. 2 is a table of the parameters that have an impact on MTEM measurements, and

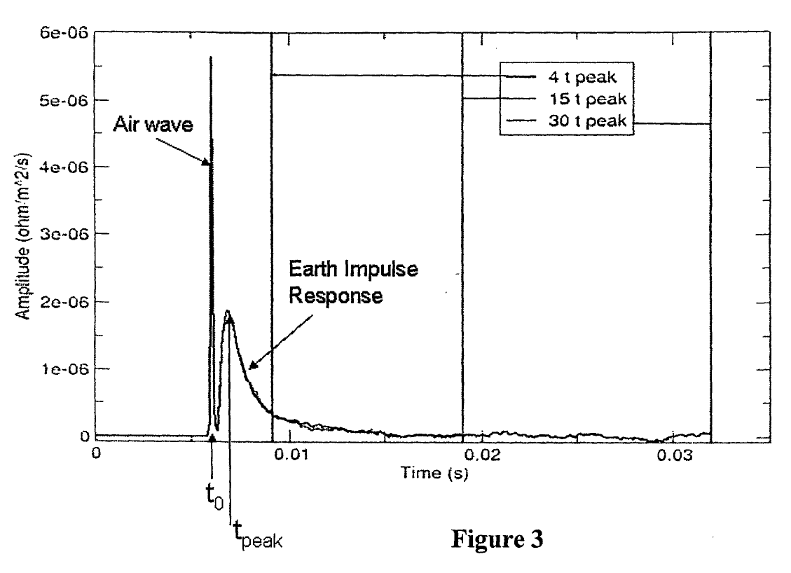

FIG. 3 is a plot of the amplitude of the earth impulse response as a function of time.

FIG. 1 shows a typical MTEM source-receiver configuration, with a current bi-pole source and its two electrodes A and B, and a line of receivers in line with the source, measuring the potential between pairs of receiver electrodes, for instance C and D. Associated with each pair of receiver electrodes is a recording instrument for digitally sampling and recording the received signal. A time-varying current is injected between the two source electrodes and is measured and digitally recorded at each receiver. The receivers are normally connected to a computer that can interrogate them and download the recorded data. The current input may be a simple step for a shallow target or, more likely some other function, such as a pseudo-random binary sequence (PRBS). The time-varying voltage response of the earth is measured and recorded at each receiver. In data processing the measured voltages are deconvolved for the measured input current to obtain the earth impulse responses. These responses are subsequently inverted to obtain the earth's subsurface resistivity variations.

The quality of the data processing and inversion depends on the quality of source and receiver measurements. Bad quality data cannot be corrected in processing and inversion. Therefore, it is necessary to be certain that the data acquired in the field are good enough. In practice, this can be a significant challenge due to the large number of potentially variable acquisition parameters—see the table of FIG. 2. Hence in practice, it is necessary to maintain some acquisition parameters substantially constant and carefully control changes in others.

It can be shown that the peak voltage of the earth response is related to the acquisition parameters by the following equation:

$$V \approx {10}^{6} \cdot Δ {x}_{s} \cdot Δ {x}_{r} \cdot I \cdot \frac{{ρ}^{2}}{{f}_{s} {r}^{5}} Volts . \qquad ( 1 )$$

The factor of r⁵ in the denominator makes it very difficult to obtain good signal at large source-receiver offsets, especially if the overburden resistivity ρ—the average resistivity from the earth's surface to the target—is low.

To be able to resolve the top and bottom of the target, it has been found that the maximum offset must be about four times the target depth; that is, rₘₐₓ≈4d. For example, for a 40-channel system (N_{box}=40) the following layout parameters might be used:

Δxₛ=d/10 (2)

Δxᵣ=d/10 (3)

rₘᵢₙ=5Δxₛ(=d/5) (4)

rₘₐₓ=5Δxₛ+39Δxᵣ(=4.4d) (5)

As the target depth increases, so does the maximum offset, which dramatically decreases the voltage at the receiver according to equation (1). The situation is mitigated to some extent by the scaling of both Δxₛ and Δxᵣ. For a particular prospect these parameters are normally kept reasonably constant, although for longer offsets it is advantageous to maximise Δxₛ provided, from equation (5), Δxₛ≦r. However, the other parameters are more variable, that is, the current I, the source switching frequency fₛ, the receiver sampling rate fᵣ, the number of PBRS samples N_{PBRS}, the listening time T_{LIST}, the number of listening samples N_{LIST}, the number of recorded samples per cycle N_{T} and the number of recorded cycles in a run N_{CYC}. The present invention is based on the recognition that some of these acquisition parameters may vary with source-receiver offset.

### Current I

The strength of the received signal is directly proportional to the current I put into the ground and signal-to-noise ratio is therefore proportional to I. If signal-to-noise ratio is a problem, especially at large source-receiver offsets, it is important to maximise the level of the source current within the limit of the applied voltage. This is done by reducing the contact resistance of the ground at the source electrodes. A number of well known methods can be used, including using electrodes in parallel, watering-in the electrodes, and adding bentonite.

Source Switching Frequency fₛ

In the land case the impulse response of the earth has a shape as shown in FIG. 3, in which t₀ is the time break, or start of data and t_{PEAK} is the time to the peak of the earth impulse response. At t₀ the source impulse travels across the surface of the earth at about the speed of light and arrives at the receivers almost instantaneously. This is the airwave. This is followed by the diffusive earth impulse response. The received signal is the convolution of the total impulse response—the airwave and the earth response—with the input signal. From equation (1) it can be seen that the amplitude of the received signal is inversely proportional to the source switching frequency fₛ. Therefore, the signal-to-noise ratio can be increased by decreasing the source current switching frequency fₛ. This is particularly important at large source-receiver offsets. Having said this, there is a limit to how low fₛ should be: the minimum time between switches Δtₛ should be small compared with the time to the peak of the earth impulse responses:

$$Δ {t}_{s} = \frac{1}{{f}_{s}} << {t}_{peak} - {t}_{0} . \qquad ( 6 )$$

Typically, we need

$$Δ {t}_{s} \approx \frac{{t}_{peak} - {t}_{0}}{10} . \qquad ( 7 )$$

Therefore, it is best to use the lowest switching frequency fₛ that still allows the peak of the earth impulse response to be separated from the airwave.

To optimise measurements, and in accordance with the present invention, it has been appreciated that it is normally not possible to obtain good resolution and good signal-to-noise ratio at all offsets with a single switching frequency fₛ. Instead, it is normally necessary to vary fₛ with offset. Hence, for the MTEM measurement configuration of FIG. 1, the switching frequency fₛ may in principle be different for each source-receiver pair.

In the marine case, the “airwave” has a different shape from the sharp impulse that occurs in the land case. Its shape depends on the depth of the water, the depths of the source and receiver below the sea surface, and the source-receiver separation. In principle the marine data can be considered as the same as the land case, but with the impulsive land airwave replaced by a longer duration wave, which is superimposed on the earth impulse response.

Receiver Sampling Rate fᵣ

At all source-receiver offsets the data should ideally satisfy two criteria (1) the peak of the earth impulse response should separate from the airwave—this is required for resolution of shallow features, and (2) the length of the impulse response T_{LIST}−t₀ should be greater than four times the time to the peak tₚₑₐₖ−t₀; that is, T_{LIST}−t₀>4(t_{PEAK}−t₀). This is essential for inversion of the data to resolve the target.

For a half-space, in this case the space below the earth's surface, the time to the peak increases as the square of the source-receiver offset r (m) and inversely as the resistivity ρ (ohm m):

$${t}_{PEAK} - {t}_{0} = \frac{{kr}^{2}}{ρ} . \qquad ( 8 )$$

The constant k has the value 4π.10⁻⁸ in SI units. At short offsets, e.g. rₘᵢₙ, and for large resistivities ρ this time is short and a high receiver sampling rate is required. At long offsets, e.g rₘₐₓ, the pulse is much longer and the receiver sampling rate can be less. At long offsets the signal is weak and the source switching frequency fₛ should be as low as possible.

There is no point in over-sampling the received data, but the received data must be adequately sampled, so the receiver sampling rate fᵣ must be equal to, or greater than the source switching frequency:

fᵣ≧fₛ. (9)

Ideally fᵣ=fₛ, but in practice this may not be possible because of limitations in the receiver electronics. If this is the case, it would be convenient if fᵣ were an exact multiple of fₛ:

fᵣ=mfₛ, (10)

where m is an integer.

### Number of PBRS Samples N_{PBRS}

The number of PRBS samples at the source is N_{PRBS}=2ⁿ−1, where n is known as the order of the PRBS. Provided the source switching frequency fₛ is low enough, the processing gain in signal amplitude after deconvolution is almost equal to N_{PRBS} and much greater than \sqrt{N_{PRBS}}. To obtain adequate data for the minimum cost, a single long PRBS is used and only one record is recorded.

### Listening Time T_{LIST} and Number of Listening Samples N_{LIST}

After deconvolution the recovered impulse response must be long enough; that is, the recoverable length of the impulse response must be greater than four times the time to the peak, as explained above. Listening time and number of listening samples are defined as:

T_{LIST}−t₀≧4(tₚₑₐₖ−t₀). (11)

N_{LIST}=T_{LIST}/fᵣ. (12)

Number of Recorded Samples Per Cycle N_{T}

If the source switching frequency and the sampling rate at the receiver are equal (that is if fᵣ=fₛ), the total number of recorded samples is equal to the number of PRBS samples plus the listening samples:

N_{T}=N_{PRBS}+N_{LIST} (13)

If the source switching frequency and the sampling rate at the receiver are not equal (that is, if fᵣ=mfₛ), the total number of samples is greater:

$$\begin{matrix}{N}_{T} = \frac{{f}_{r}}{{f}_{s}} \cdot {N}_{PRBS} + {N}_{LIST} \\ = m \cdot {N}_{PRBS} + {N}_{LIST}\end{matrix} \qquad ( 14 )$$

### Number of Recorded Cycles in a Run N_{CYC}

If the recording system has a memory that is too small, it may be impossible to obtain adequate signal-to-noise ratio with a single PRBS cycle: that is, with only one recording of N_{T} samples per channel. In this case a run of N_{CYC} cycles is recorded and the resulting traces are summed, or stacked, for each channel to increase the signal-to-noise ratio before deconvolution. The signal-to-noise ratio increases as \sqrt{N_{CYC}}. It is clearly most efficient to maximize N_{PRBS} and to minimize N_{CYC}. This can be achieved only if there is sufficient memory in the recording boxes.

### Operational Considerations

It will be clear from the above that the ratio of the longest offset rₘₐₓ to the shortest rₘᵢₙ is about 10. Since the switching frequency fₛ and sampling rate fᵣ may both vary as the square of the offset, these two frequencies vary by about two orders of magnitude from the shortest to the longest offset. In the arrangement of FIG. 1, it will not be possible for the single source to switch at different frequencies simultaneously, although it is possible to measure and record at all receivers simultaneously. Instead, to meet the requirements above, a range of source switching frequencies for each source position should be used, each source switching frequency being selected for addressing a particular range of receivers based on the source-receiver offset. For the single source example of FIG. 1, this means that the source would typically transmit signals of different frequency bandwidths, determined by the switching frequency, and the receiver/recording systems would record using the corresponding sampling rate. The data would be sorted according to offset and processed with the appropriate bandwidth source signal. Alternatively, multiple sources having non-overlapping frequency bandwidths could be used. In this case, signals could be transmitted simultaneously. However, when this is done, the receiver/recording system combination would have to be configured to enable the different frequency bandwidths to be separated out. In either case, the recording system must have the flexibility to cope with the range of frequency bandwidths posed by MTEM data.

A skilled person will appreciate that variations of the disclosed arrangements are possible without departing from the invention. Alternative configurations are clearly possible. Accordingly the above description of the specific embodiment is made by way of example only and not for the purposes of limitation. It will be clear to the skilled person that minor modifications may be made without significant changes to the operation described.

1. A method of optimising electromagnetic surveying comprising applying current to a current source, receiving a signal at one or more voltage receivers and recording the signals received, characterised in that the method involves varying one or more acquisition parameters as a function of the source-receiver separation.

2. A method as claimed in claim 1 wherein the acquisition parameters that are varied comprise at least one of a switching frequency at the source and a sampling frequency in the recording system.

3. A method as claimed in claim 2 comprising varying the switching frequency and/or the sampling frequency inversely as the square of the source-receiver separation.

4. A method as claimed in any of the preceding claims comprising varying the separation between the source electrodes and the separation between receiver electrodes.

5. A method as claimed in claim 4 wherein the separation is varied in proportion to a target survey depth and/or to the separation between source and receiver.

6. An electromagnetic surveying system comprising a current source, and one or more voltage receivers for receiving and recording received signals, characterised in that one or more acquisition parameters used by the source and/or the or each receiver is selected as a function of the source-receiver separation.

7. A system as claimed in claim 6 wherein the acquisition parameters are at least one of a switching frequency at the source and a sampling frequency in the recording system.

8. A system as claimed in claim 7 wherein the switching frequency and/or the sampling frequency is selected inversely as the square of the source-receiver separation.

9. A system as claimed in any of claims 6 to 8 wherein the separation between the source electrodes and the separation between receiver electrodes is selected as a function of a target survey depth and/or to the separation between source and receiver.

10. A system as claimed in any of claims 6 to 8 wherein a plurality of receivers is provided and the source is operable to provide a current at a plurality of different frequency bandwidths, each frequency bandwidth being selected as a function of the separation of one of the receivers from the source.

11. A system as claimed in claim 10 wherein the source comprises a plurality of different sources each operable to provide current in a different frequency range.

12. A system as claimed in any of claims 6 to 8 wherein the current source comprises at least one current bipole source and the or each voltage receiver comprises at least one voltage bipole receiver.

13. The system as claimed in claim 9 wherein a plurality of receivers is provided and the source is operable to provide a current at a plurality of different frequency bandwidths, each frequency bandwidth being selected as a function of the separation of one of the receivers from the source.

14. A system as claimed in claim 9 wherein the source comprises a plurality of different sources each operable to provide current in a different frequency range.

15. A system as claimed in claim 9 wherein the current source comprises at least one current bipole source and the or each voltage receiver comprises at least one voltage bipole receiver.

16. A system as claimed in claim 10 wherein the current source comprises at least one current bipole source and the or each voltage receiver comprises at least one voltage bipole receiver.

17. A system as claimed in claim 11 wherein the current source comprises at least one current bipole source and the or each voltage receiver comprises at least one voltage bipole receiver.
